(19) United States
(12) Patent Application Publication
(10) Pub. No.: US 2008/0155495 A1
(43) Pub. Date: Jun. 26, 2008

(54) METHODS AND APPARATUS FOR MODELING A WORKFLOW PROCESS IN AN OFFLINE ENVIRONMENT

(75) Inventors: Adriaan Van Wyk, Strubensvalley (ZA); Natachya Raath, Vanderbijlpark (ZA); Lenz le Roux, Radiokop (ZA); Wynand du Toit, Little Falls (ZA); Ben Fourie, Radiokop (ZA); Schalk de Jager, Weltevreden Park (ZA); Pieter Janson, Centruion (ZA); Olaf Wagner, Issaquah, WA (US)

Correspondence Address: BELL, BOYD & LLOYD, LLP, P.O. Box 1135, CHICAGO, IL, 60690, US

(73) Assignee: SOURCECODE TECHNOLOGY HOLDING, INC., Redmond, WA (US)

(21) Appl. No.: 11/945,882

(22) Filed: Nov. 27, 2007

Related U.S. Application Data
(60) Provisional application No. 60/939,282, filed on May 21, 2007.
(60) Provisional application No. 60/867,344, filed on Nov. 27, 2006.

(51) Int. Cl. G06F 9/44

(52) U.S. Cl. 717/105

(57) ABSTRACT

The present disclosure provides methods and apparatuses for designing business processes without being connected to a process server. Using the methods and apparatus herein, users can fully model a business process, business entity, or business policy without being connected to a process server, or in an offline mode.

### CROSS-REFERENCE TO RELATED APPLICATIONS

The present application claims benefit to U.S. Patent Application No. 60/867,344, METHOD AND APPARATUS FOR CREATING WORK FLOW, filed on Nov. 27, 2006; and U.S. Patent Application No. 60/939,282, METHODS AND APPARATUS FOR MODELING A WORKFLOW PROCESS IN AN OFFLINE ENVIRONMENT, filed on May 21, 2007, the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Business can now also incorporate business process design into their existing technology systems. Instead of providing a simple map of a business process, integration with computer systems allows business process designers to design interactive business processes that drive business workflow. Business process designers can receive data from various sources and perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Business process design is typically performed on a terminal connected to a process server. The process server is able to execute the business process and connect with external data sources. When the business process designer wishes to continue to design an in environment that is not connected to a process server, the business process designer often does not have access to the necessary tools and functions.

Additionally, business process designers very quickly find that they are configuring components of a process the same way over and over again in multiple processes. Although wizard-driven design patterns and productivity enhancements make designing processes faster than ever, they still do not eliminate the need to design the same configuration more than once. The business process designer has no capability to “save” a component of work in the process design for reuse in future designs.

### SUMMARY

The present disclosure provides methods and apparatuses for designing business processes without being connected to a process server. Using the methods and apparatus herein, users can fully model a business process, business entity, or business policy without being connected to a process server, or in an offline mode.

Using the methods and apparatus herein, users can also save components of work in the process design for reuse in future designs.

Additional features and advantages are described herein, and will be apparent from, the following Detailed Description and the figures.

### BRIEF DESCRIPTION OF THE FIGURES

FIG. 1 is a high level block diagram of an example business process design system.

FIG. 2 is a more detailed block diagram showing one example of a client device.

FIG. 3 is a more detailed block diagram showing one example of a server.

FIG. 4 is a diagram of an example artifact library system.

FIG. 5 is a screenshot of an example artifact items table.

FIG. 6 is a screenshot of an example artifact library plugin.

FIG. 7 is a screenshot of an example artifact publishing wizard naming screen.

FIG. 8 is a screenshot of an example artifact publishing wizard placeholder screen.

FIG. 9 is a screenshot of an example event wizard screen.

FIG. 10 is a screenshot of an example artifact publishing wizard edit placeholder screen.

FIG. 11 is a screenshot of an example creating offline cache screen.

FIG. 12 is a screenshot of an example begin synchronization screen.

FIG. 13 is a screenshot of an example summary conflict screen.

FIG. 14 is a screenshot of an example resolve conflict screen.

FIG. 15 is a screenshot of an example commit offline changes screen.

### DETAILED DESCRIPTION

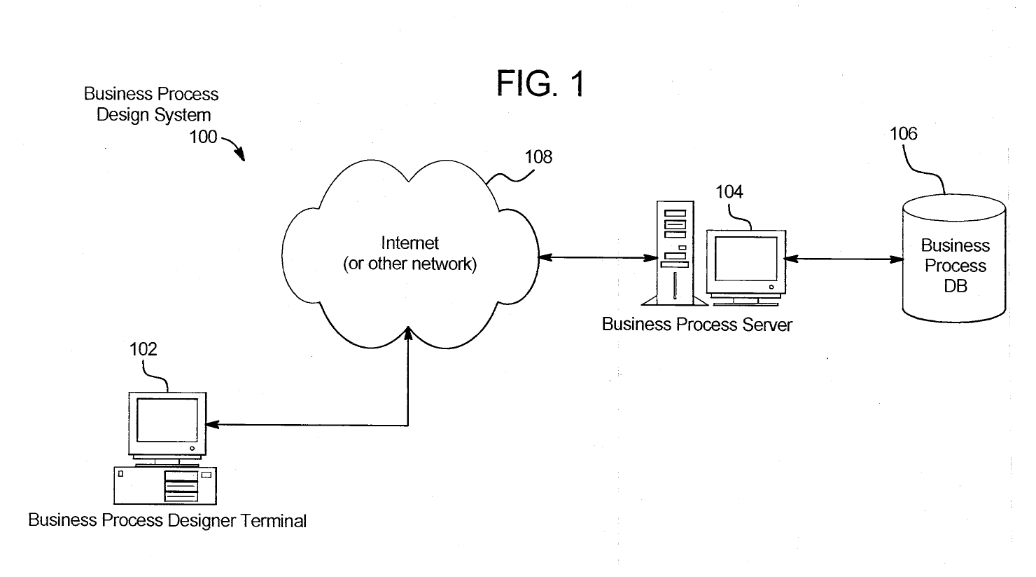

The present system is most readily realized in a network communications system. A high level block diagram of an exemplary network communications system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

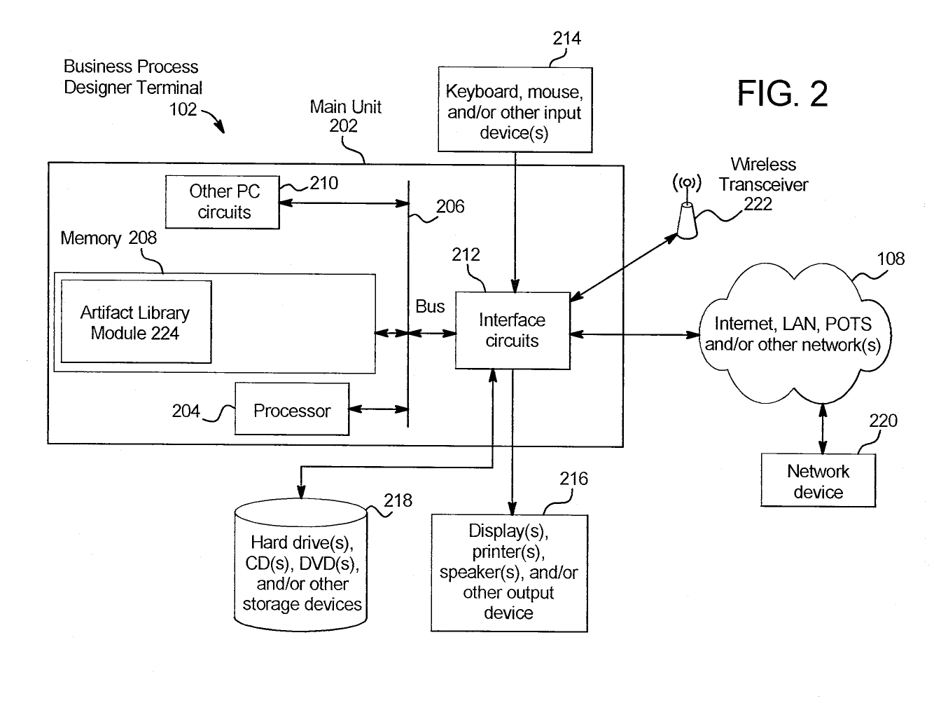

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

In particular, the memory 208 preferably stores an artifact library module 224. The artifact library module 224 allows for the creation, management and use of items on the business process designer terminal 102, when the business process designer terminal 102 is disconnected from the business process server 104.

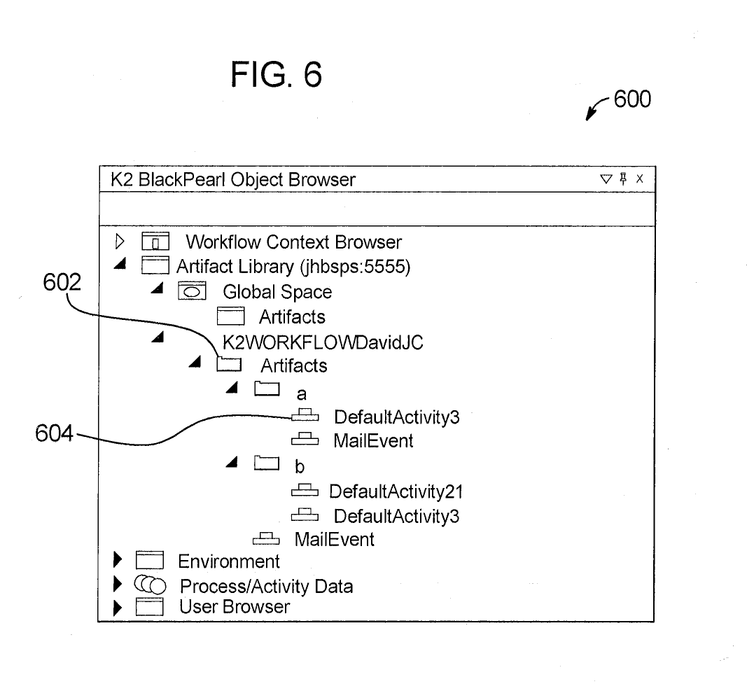

The artifact library module 224 may include a program to allow the business process designer to access artifact information from either the business process server 104 or from the storage device 218. For example the artifact library module 224 may include an artifact library plugin, shown in FIG. 6. The artifact library plugin may make use of plugin architecture to expose the artifact library data to the business process designer. The plugin may interface with the artifact sharing module 314 to access the artifact library on the business process server 104. The plugin may also interface with the storage device 218 to retrieve artifact library information when the business process designer terminal 102 is not connected to the business process server 104.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

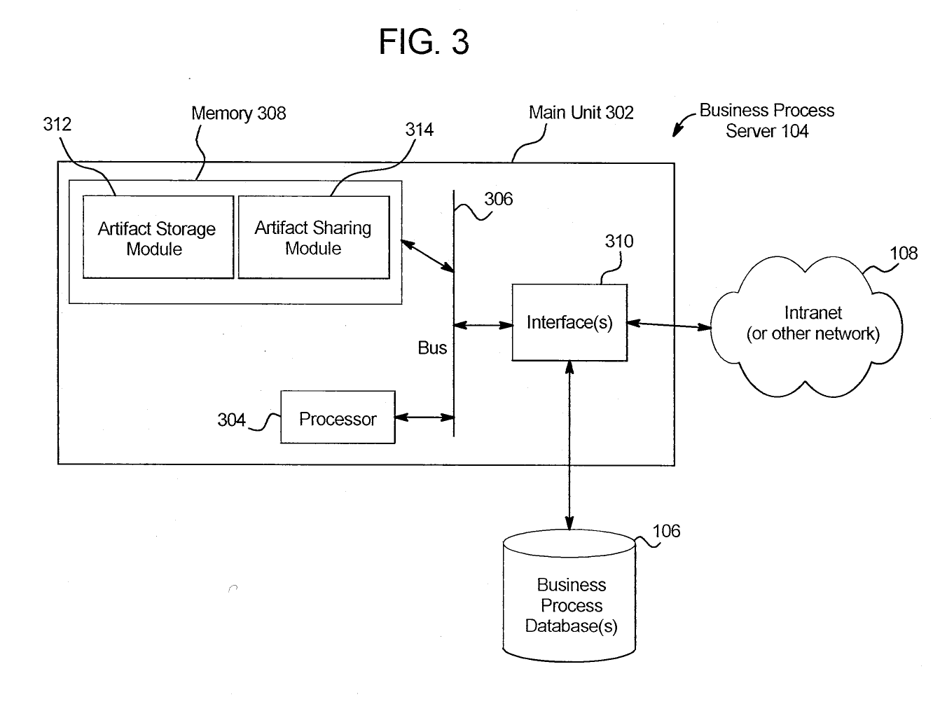

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

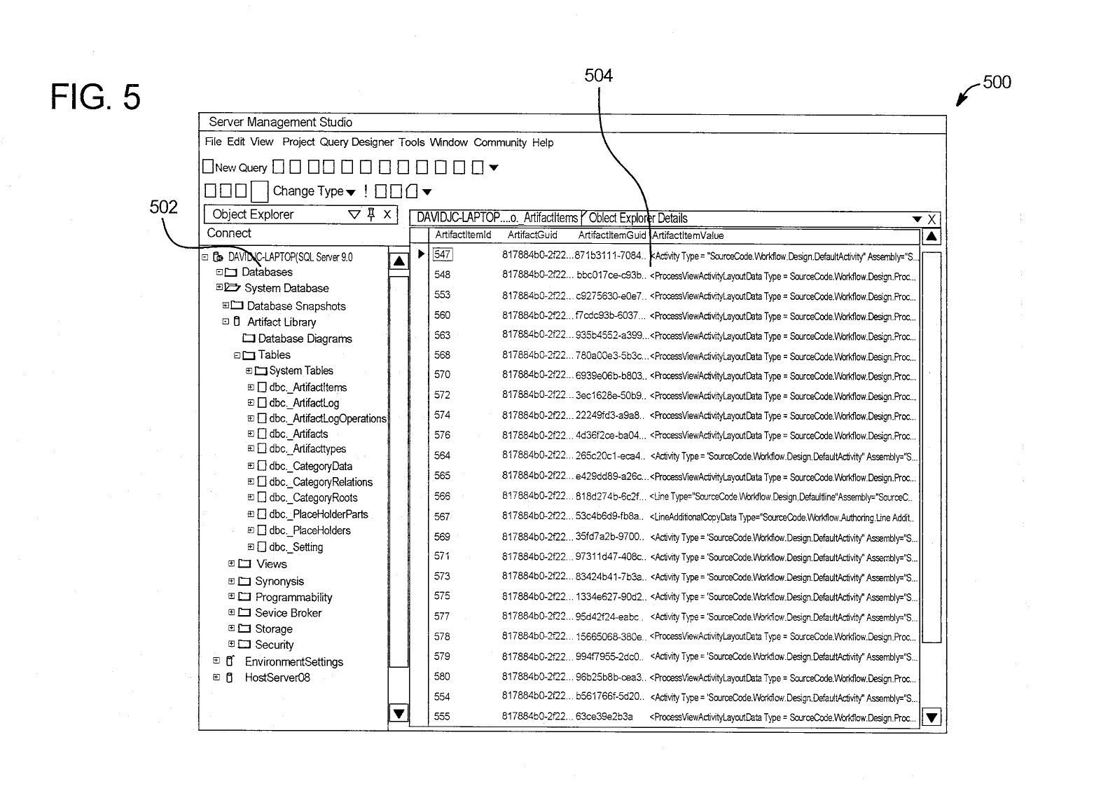

In particular, the memory 308 preferably stores an artifact storage module 312 and an artifact sharing module 314. The artifact storage module 312 may interface with the business process database 106 to store information regarding business process artifacts For an example screenshot of the artifact library storage in the database 106 see FIG. 5.

The business process designer may wish to save a component for further use. For example, the designer might find that for every process they design they configure a Mail Event to send an email every time they configure an activity to handle the outcome for a user selecting “Declined” as an action. The designer may wish to configure the Mail Event in such a way that it could be saved for reuse later. artifact storage module 312 allows the user to save activities. The business process designer can fully, or partially, configure an Event, an Activity, with 0 to many events, or multiple Activities on a process and then save them to the Artifact Library for future use. The business process database 106 may store all artifact data. The artifact storage module 312 may index the artifact data to improve performance. For example, the artifact storage module 312 may create an indexed listing of the artifact data so that external programs can quickly access the correct artifact.

When creating a new artifact, the artifact storage module 312 may first determine a user's security permissions. For example, if a user is not permitted to create artifacts in a given category, the artifact storage module 312 may not permit the user to create the new artifact. Creating a new artifact will be discussed further in relation to FIGS. 6-12.

The business process designer may also wish to set a security level for a newly created object. The business process storage module 312 allows the business process designer to set a security level. For example, the business process designer may wish to restrict access to an artifact based on group permissions. The business process storage module 312 may restrict access to the artifact based on the business process designer's settings. In another example, the business process designer could set the artifact to “Private” where only the business process designer could access the artifact. Permission levels may cascade down the directory structure, to preserve security integrity. New artifacts may inherit permissions from its parent. Different levels of security may include: read only—so that a mapped user may not add or remove artifacts from a category or its children; modify—so that the mapped user may add, edit or remove artifacts or categories from a category or its children; etc.

The artifact sharing module 314 may process the artifact library objects to allow easy use to software processes that interface with the artifact sharing module 314. For example, the artifact sharing module 314 may receive data associated with an artifact library object from the business process database 106, and expose the data as PersistableObjectCollections. The artifact sharing module 314 may also provide extra functionality to the artifact library. For example, the artifact sharing module 314 may allow searching of the artifact library objects. The artifact sharing module 314 may also associate an image with an artifact. For example, a workflow process stored in the artifact library may be represented with geometric shapes indicative of the type of workflow process. In another example, the artifact sharing module 314 may create a thumbnail, representative of a workflow process to represent an artifact library process.

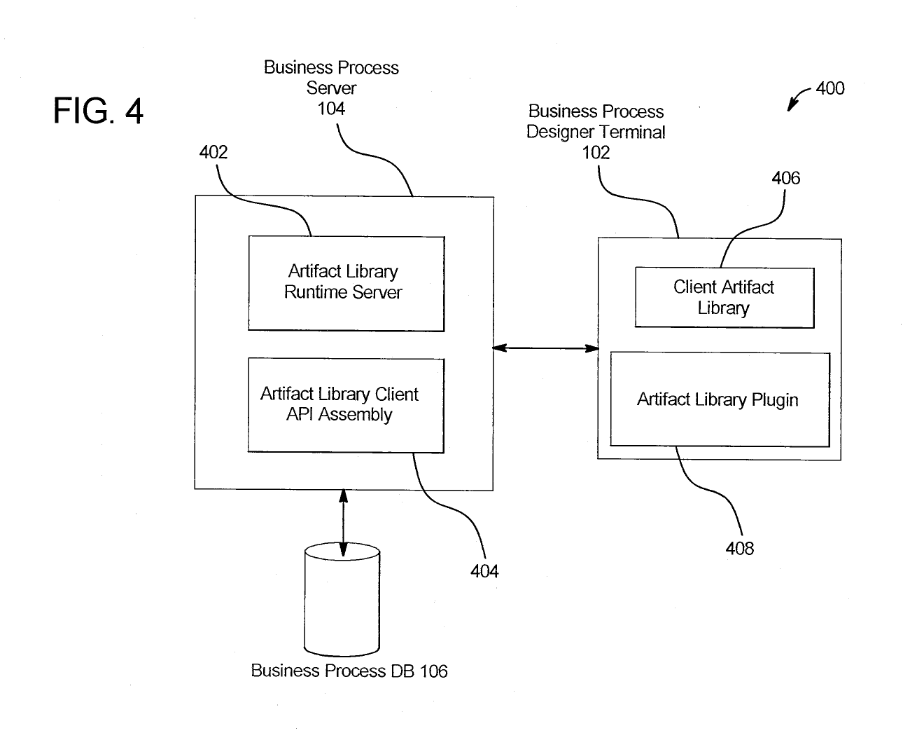

A diagram of an example artifact library system 400 is presented in FIG. 4. Although the example artifact library system 400 is described in reference FIG. 4, it will be appreciated that many other configurations are possible. For example, elements could be in different locations, elements could have different names, and elements could have different graphical representations.

The artifact library system 400 may have a business process server 104 and a business process designer terminal 102. It should be understood that the business process server 102 may be a plurality of connected servers and that components may be located on separate servers. The business process server 104 may have an artifact library runtime server component 402 and an artifact library client API assembly 404.

The artifact library runtime server component 402 and the artifact library client API assembly 404 may be controlled by the artifact sharing module 314 located in the memory 308 of the business process server 104. The artifact library runtime server 402 may be responsible for making the artifact library stored procedures accessible to the business process designer terminal 102. The artifact library runtime server 402 decides what data the business process designer terminal 102 is allowed to receive.

The artifact library client API assembly 404, may process the artifact library objects to allow easy use to software processes that interface with the artifact sharing module 314. For example, the artifact sharing module 314 may receive data associated with an artifact library object from the business process database 106, and expose the data as PresistableObjectCollections.

The business process designer terminal 102 may include a client artifact library 406 and an artifact library plugin 408. The client artifact library 406 may store localized copies of artifact objects when the business process designer terminal 102 is not connected to the business process server 104. The artifact library plugin 408 may interface with the artifact library client API assembly 404 when the business process designer terminal 102 is connected to the business process server 104, and connect to the client artifact library 406 when the business process designer terminal 102 is not connected to the business process server 104.

The artifact library system 400 may also have a business process database 106. The business process database 106 may store the artifact library database.

A screenshot of an example artifact items table 500 is presented in FIG. 5. Although the example artifact items table 500 is described in reference FIG. 5, it will be appreciated that many other configurations are possible. For example, elements could be in different locations, elements could have different names, and elements could have different graphical representations.

The artifact items table 500 may represent the artifacts stored in the business process database 106. The artifact items table 500 may indicate a plurality of databases that store artifact items. For example, the artifact items table 500 may show a file viewer 502 that shows the plurality of databases that store artifact items. The artifact items table 500 may also contain a detailed description of the artifact items stored in a given database. For example, a detailed view 504 may provide information such as the artifact identification number, the artifact data values, etc.

A screenshot of an example artifact library plugin 600 is presented in FIG. 6. Although the example artifact library plugin 600 is described in reference FIG. 6, it will be appreciated that many other configurations are possible. For example, elements could be in different locations, elements could have different names, and elements could have different graphical representations.

The artifact library plugin 408 interfaces with the artifact library client API assembly 404 to expose the artifact library data to the business process designer at the business process designer terminal 102. The artifact library plugin 408 only allows viewing of artifacts that the business process designer has permission to view. The artifact library plugin 408 may have categorize the artifacts available to the business process designer. For example, the artifact library plugin may display an artifacts folder 602 and individual artifacts 604 that the user may access. The business process designer may wish to publish a new artifact. The business process designer may drag a part of the process over a category of the library plugin 408. The library plugin 408 may interact with the artifact library client API assembly 404 to save serialized data streams into the business process database 106.

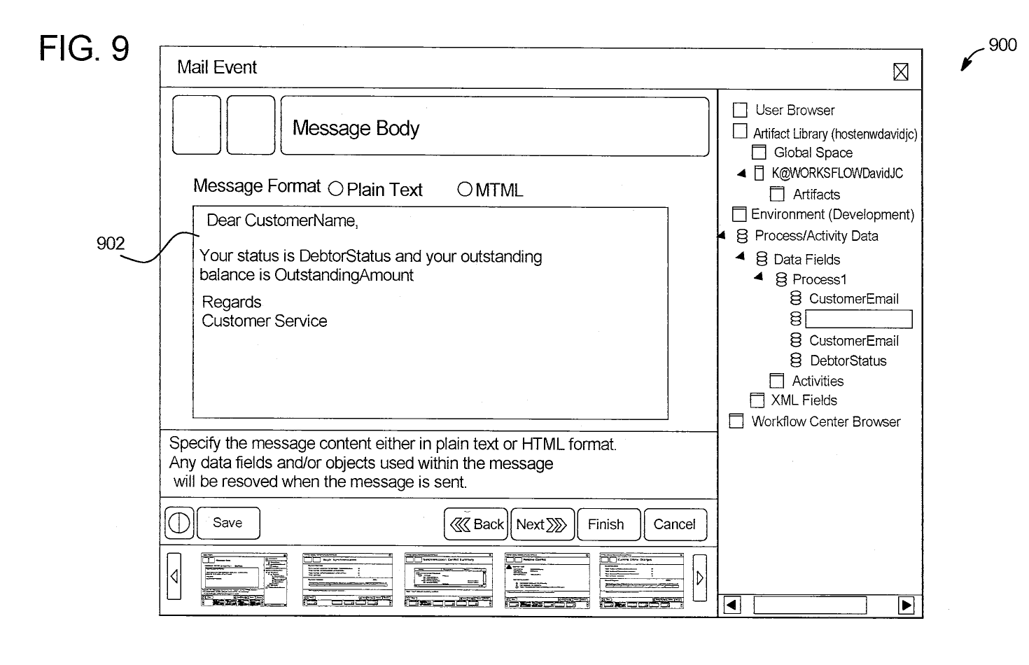

The artifact library plugin 408 also handles the insertion of an artifact into a canvas. The artifact library plugin 408 will execute different logic depending on the type of artifact being inserted. If the artifact contains placeholders, as shown in FIG. 9, the artifact library plugin 408 will process the serialized data streams and add the streams associated with the artifact to the canvas. When the artifact does not contain placeholders, the artifact library plugin 408 may place the artifact on the canvas with the streams processed directly by the canvas. In other words, the business process designer can map the placeholders directly from the canvas, instead of using streams already associated with the artifact. A wizard may assist the business process designer to map the placeholders to the data streams that the business process designer wishes to populate the placeholder fields.

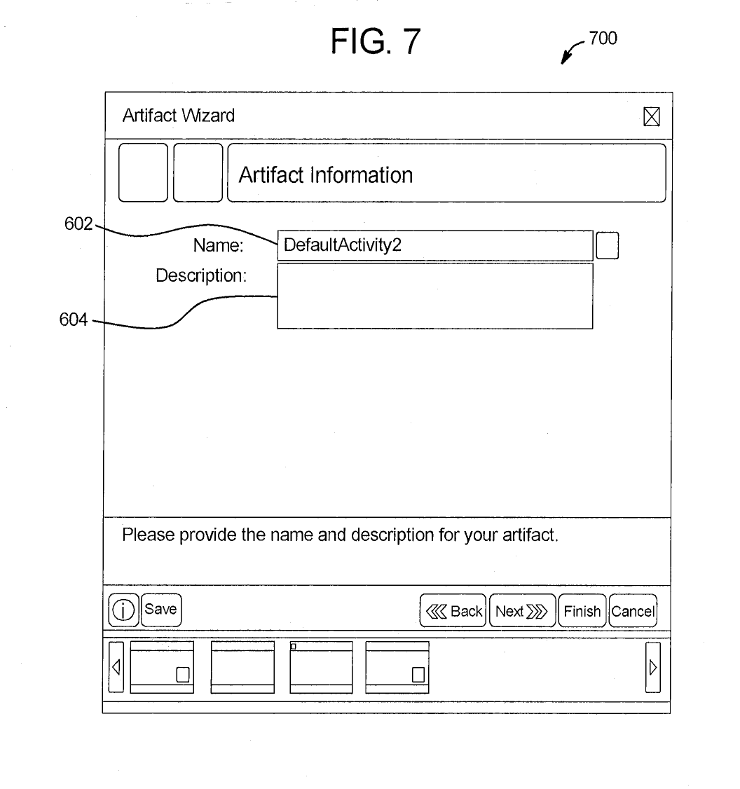

A screenshot of an example artifact publishing wizard naming screen 700 is presented in FIG. 7. Although the example artifact publishing wizard naming screen 700 is described in reference FIG. 7, it will be appreciated that many other configurations are possible. For example, elements could be in different locations, elements could have different names, and elements could have different graphical representations.

The artifact publishing wizard naming screen 700 may include fields to allow the business process developer to enter a name 602 and a description 604.

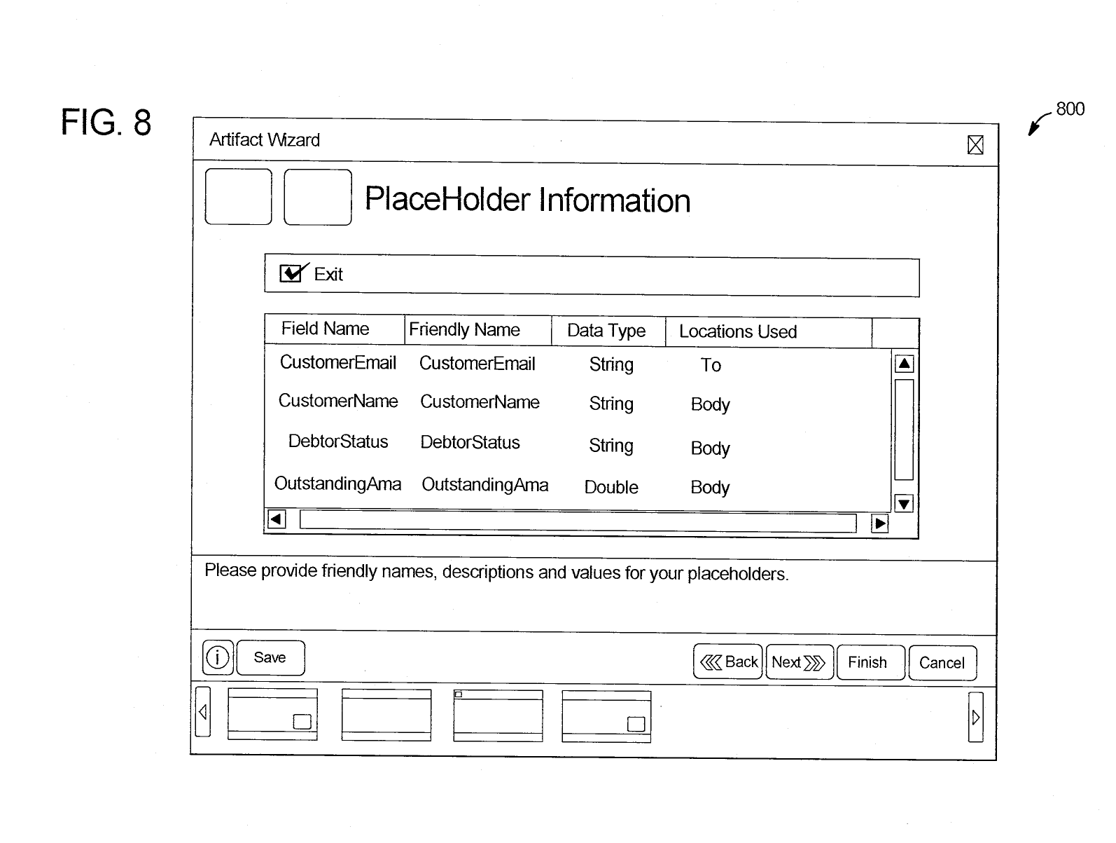

A screenshot of an example artifact publishing wizard placeholder screen 800 is presented in FIG. 8. Although the example artifact publishing wizard placeholder screen 800 is described in reference FIG. 8, it will be appreciated that many other configurations are possible. For example, elements could be in different locations, elements could have different names, and elements could have different graphical representations.

The artifact publishing wizard placeholder screen 800 may display when a business process designer has configured an event apart from the artifact library and then wishes to add their event to the artifact library. For example, the business process designer may have already created the “Mail” event using a wizard as shown in FIG. 9. The “Mail” event may have a number of fields that require placeholder information. For example, The “Mail” event may have a “CustomerEmail” field 902. The placeholder screen 800 may allow the business process designer to designate fields that will be updated with data when the process is run. For example, the “CustomerEmail” field 802.

A screenshot of an example event wizard screen 900 is presented in FIG. 9. Although the event wizard screen 900 is described in reference FIG. 9, it will be appreciated that many other configurations are possible. For example, elements could be in different locations, elements could have different names, and elements could have different graphical representations.

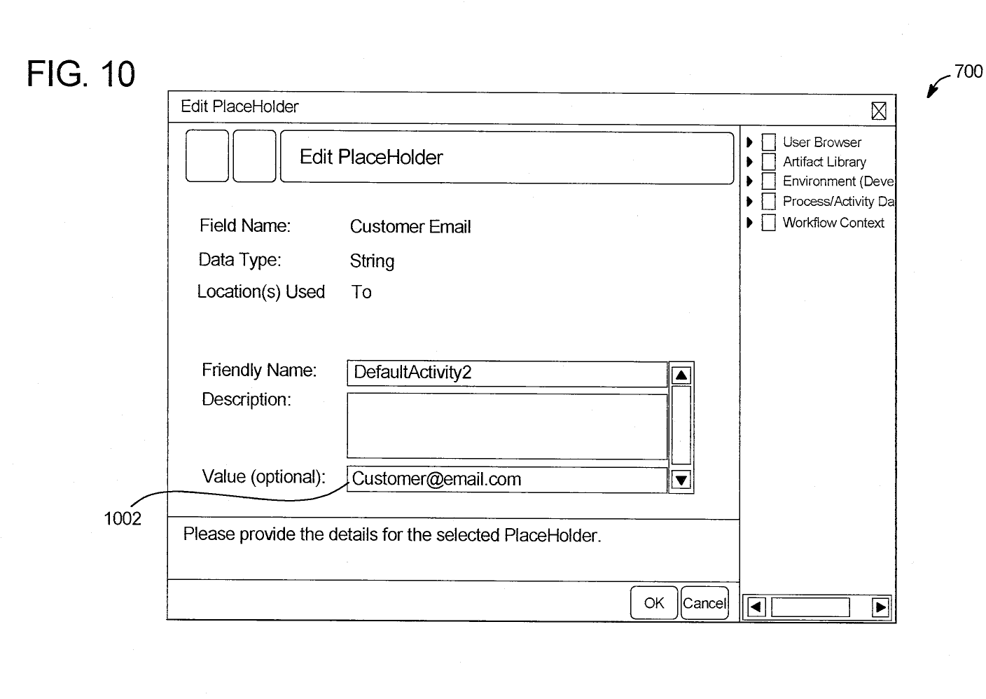

A screenshot of an example artifact publishing wizard edit placeholder screen 1000 is presented in FIG. 10. Although the example artifact wizard edit placeholder screen 1000 is described in reference FIG. 10, it will be appreciated that many other configurations are possible. For example, elements could be in different locations, elements could have different names, and elements could have different graphical representations.

The business designer may wish to add a hard coded value to be used for the placeholder value. The business process user can edit data directly into the placeholders. For example, in the “Email” event, a “CustomerEmail” placeholder may be edited to insert “customer@email.com” 1002 into the field on process execution.

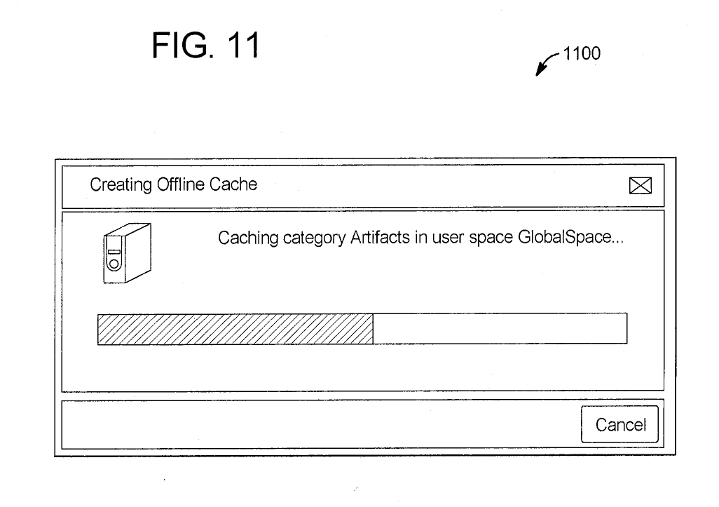

A screenshot of an example creating offline cache screen 1100 is presented in FIG. 11. Although the example caching offline screen 1100 is described in reference FIG. 11, it will be appreciated that many other configurations are possible. For example, elements could be in different locations, elements could have different names, and elements could have different graphical representations.

The business process designer may wish to work without being connected to the business process server 104. For example, the business process designer may select a “Work Offline” function. The business process designer may be presented with a creating offline cache screen 1100. The offline cache may allow the business process designer to use workflow objects without being connected to the business process server 104. The creating offline cache screen 1100 may contain a caching progress bar.

When caching, the artifact library plugin 408 interfaces with the artifact library client API assembly 404 may recursively query the business process server 104 asking for all data, which is then cached into the client artifact library 406 which may be stored on the storage device 218. User rights may also be cached.

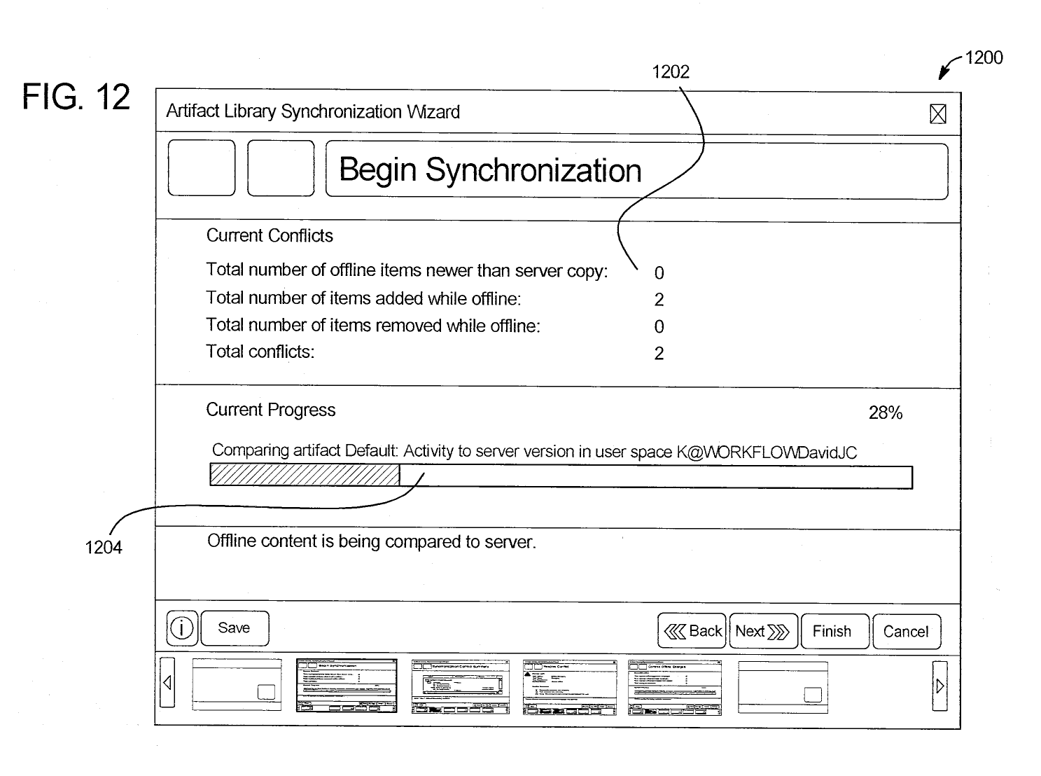

A screenshot of an example begin synchronization screen 1200 is presented in FIG. 12. Although the example begin synchronization screen 1200 is described in reference FIG. 12, it will be appreciated that many other configurations are possible. For example, elements could be in different locations, elements could have different names, and elements could have different graphical representations.

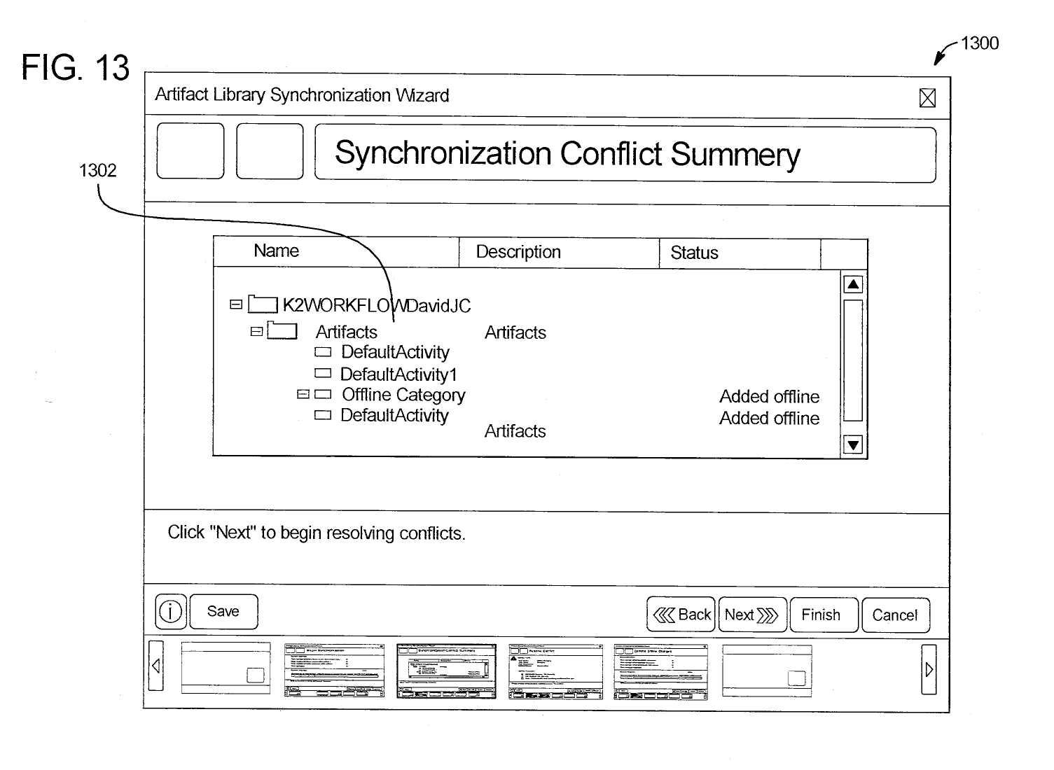

The begin synchronization screen 1200 may be displayed to the user when the business process developer terminal 102 is reconnected to the business process server 104. The artifact library plugin 408 interfaces with the artifact library client API assembly 404 to determine if any conflicts exist between the client artifact library 406 and the artifacts on the business process database 106. A listing of modified artifacts may be displayed on the begin synchronization screen 1200. For example, a conflict listing 1202 may be displayed along with a progress bar 1204. The conflicts may be displayed in another form such as that shown in FIG. 13, etc. Specific artifacts that are in conflict 1302 may be identified.

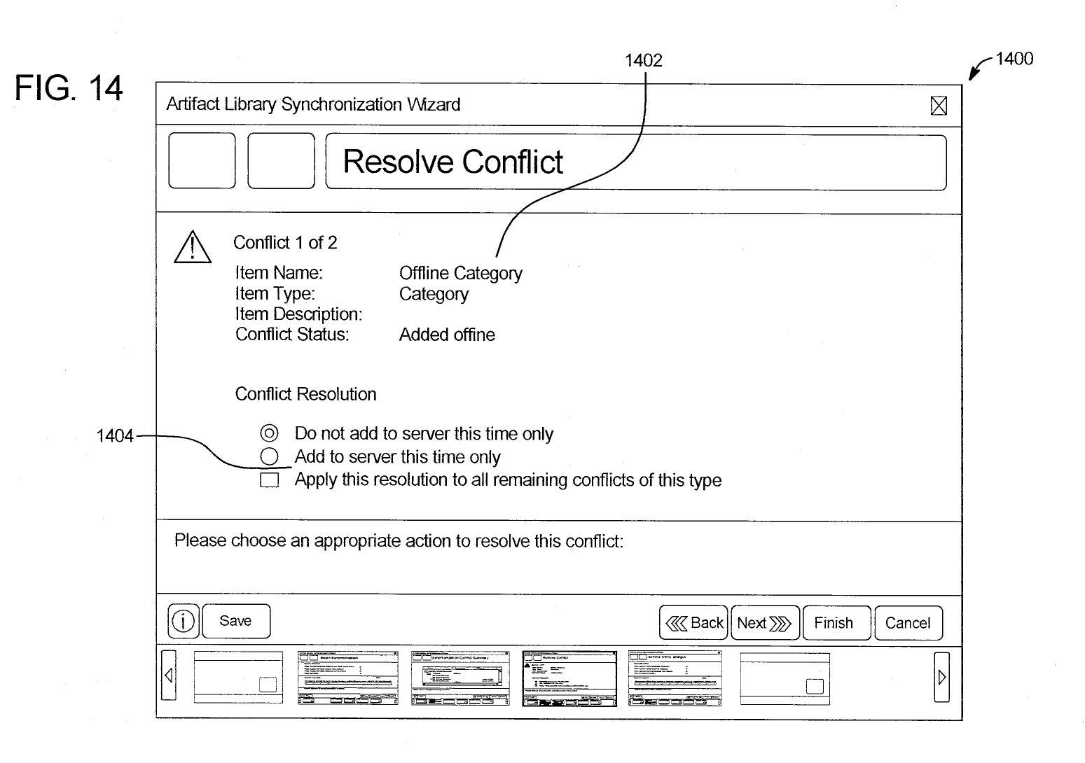

A screenshot of an example resolve conflict screen 1400 is presented in FIG. 14. Although the example resolve conflict screen 1400 is described in reference FIG. 14, it will be appreciated that many other configurations are possible. For example, elements could be in different locations, elements could have different names, and elements could have different graphical representations.

The resolve conflict screen 1400 may have artifact identifying information 1402 and a conflict resolution choice 1404. For example, the conflict resolution choice 1404 may include the options “Do not add to server,” “Add to server,” “Apply choice to all remaining conflicts,” etc.

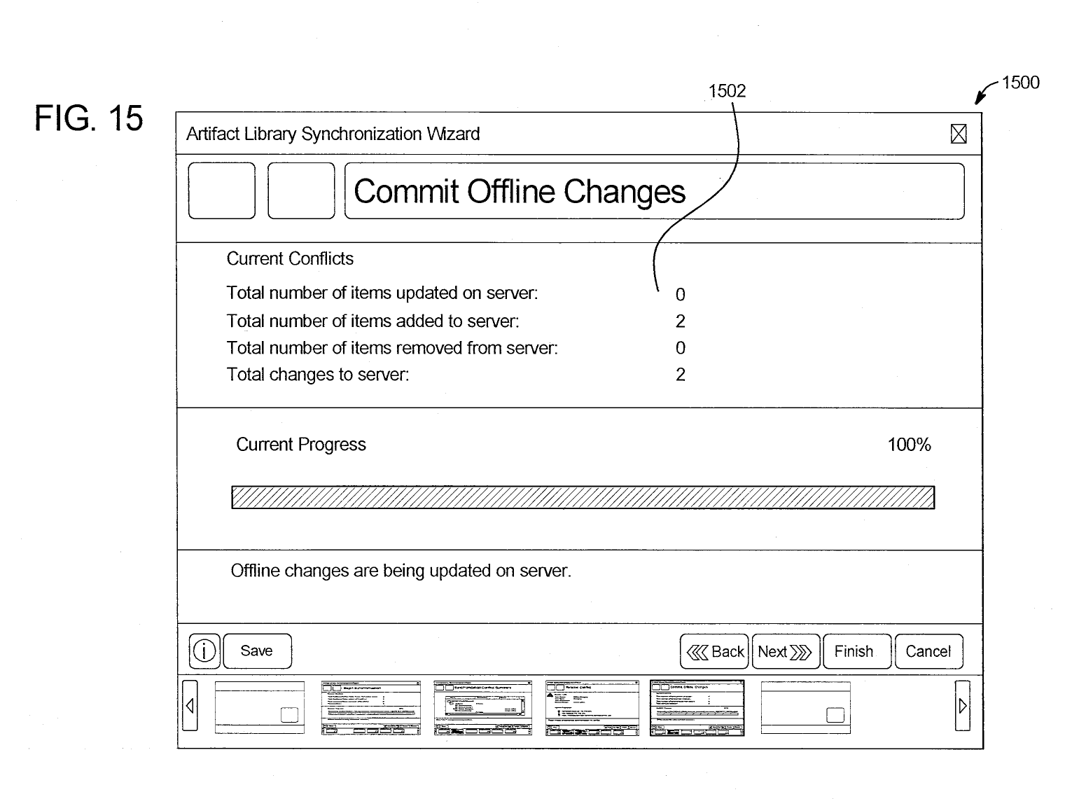

A screenshot of an example commit offline changes screen 1500 is presented in FIG. 15. Although the example commit offline changes screen 1500 is described in reference FIG. 15, it will be appreciated that many other configurations are possible. For example, elements could be in different locations, elements could have different names, and elements could have different graphical representations.

The commit offline changes screen 1500 may contain a conflict summary 1502. For example, the conflict summary 1502 may detail the number of items updated to the server, number of items added to the server, etc.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for using workflow artifacts in an offline environment comprising:
creating a business process object;
storing the business process object in a first artifact library at a first location;
storing the business process object in a second artifact library at a second location;
creating a modified business process object in the second artifact library where the second artifact library is not connected to the first artifact library;
connecting the first artifact library to the second artifact library; and
updating the business process object in the first artifact library based on the modified business process object in the second artifact library and the business process object in the first artifact library.

2. The method of claim 1, including associating a security level with the business process object.

3. The method of claim 1, wherein creating a business process object includes displaying an artifact creation wizard.

4. The method of claim 1, including using the business process object in a workflow.

5. The method of claim 4, wherein the business process object includes a placeholder value.

6. The method of claim 5, including replacing the placeholder value with a serialized data stream, where the serialized data stream is associated with the workflow.

7. A system for using workflow artifacts in an offline environment, the system comprising:
a first memory capable of storing a business process object in a first artifact library at a first location;
a second memory capable of storing the business process object in a second artifact library at a second location;
a first processor to create a modified business process object in the second artifact library where the second artifact library is not connected to the first artifact library;
a network connection to connect the first artifact library to the second artifact library; and
a second processor to update the business process object in the first artifact library based on the modified business process object in the second artifact library and the business process object in the first artifact library.

8. The system of claim 7, wherein the second processor creates the business process object.

9. The system of claim 8, wherein the second processor causes a display to display an artifact creation wizard.

10. The method of claim 8, wherein the second processor associates a placeholder value with the business process object.

11. The method of claim 10, wherein the first processor replaces the placeholder value with a serialized data stream.

12. The system of claim 7, wherein the second processor associates a security level with the business process object.

13. The system of claim 7, wherein the first processor creates a second processor element.

14. The system of claim 13, wherein the first processor updates the first artifact library with the second business process object.

15. A computer readable medium storing instructions structured to cause a computing device to:
receive a business process object from a first artifact library;
storing the business process object in a second artifact library;
receive an instruction to disconnect from the first artifact library;
disconnect from the first artifact library;
create a modified business process object in the second artifact library;
connect the second artifact library to the first artifact library; and
update the business process object in the first artifact library based on the modified business process object in the second artifact library.

16. The computer readable medium of claim 15, wherein the instructions are structured to cause the computing device to create a second business process object in the second artifact library.

17. The computer readable medium of claim 16, wherein the instructions are structured to cause the computing device to display an artifact creation wizard.

18. The computer readable medium of claim 16, wherein the instructions are structured to cause the computing device to update the first artifact library with the second business process object.

19. The computer readable medium of claim 16, wherein the instructions are structured to cause the computing device to associate a security level with the second business process object.

20. The computer readable medium of claim 16, wherein the instructions are structured to cause the computing device to associate a placeholder value with the second business process object.

21. The computer readable medium of claim 20, wherein the instructions are structured to cause the computing device to replace the placeholder value with a serialized data stream, where the serialized data stream is associated with the workflow process.
